(19) United States
(12) Patent Application Publication
(10) Pub. No.: US 2015/0306810 A1
(43) Pub. Date: Oct. 29, 2015

(54) METHOD OF PRODUCING AN INSULATING WINDOW TREATMENT

(71) Applicant: Forest Edward Bolton, Providence, RI (US)

(72) Inventor: Forest Edward Bolton, Providence, RI (US)

(73) Assignee: CORONA CURTAIN MANUFACTURING, West Warwick, RI (US)

(21) Appl. No.: 14/695,371

(22) Filed: Apr. 24, 2015

Related U.S. Application Data
(60) Provisional application No. 61/983,539, filed on Apr. 24, 2014.

(51) Int. Cl. B29C 53/18; D06M 10/00

(52) U.S. Cl. CPC B29C 53/18; D06M 10/00; B29K 2105/0809

(57) ABSTRACT

A fabric processing method is provided to enhance the thermal performance of window treatments while maintaining their light and sheer decorating value and aesthetic appearance. The method uses heat and pressure to enhance the ability of the fabric to reduce thermal transfer therethrough while preserving overall hand, feel and appearance of the fabrics allowing even sheer fabric window treatments to provide enhanced energy efficiency. The fabric, preferably containing a polymeric component such as polyester or the like, is subjected to pressure and increased temperature to create a material fusion that resists thermal transfer as compared to the unprocessed fabric itself.

### CROSS-REFERENCE TO RELATED APPLICATIONS

This application is related to and claims priority from earlier filed US Provisional Patent Application No. 61/983,539, filed Apr. 24, 2014.

### BACKGROUND OF THE INVENTION

The present invention relates, in general, to a fabric processing method developed for the purpose of reducing thermal energy transfer through the fabric. More particularly, the present invention relates to a method for the processing of fabric in a manner that that provides insulation against heat loss or heat gain depending on the intended application.

The three well know mechanisms of thermal energy transfer are conduction, convection and radiation. Conduction occurs as a result of direct contact between a hotter substance and a colder substance. Convection is the transfer of energy between an object and its environment due to fluid motion. Radiation is the transmittance of thermal energy through space in the form of electromagnetic waves. Thus in conserving energy there is a need to provide the capability to reduce all three mechanisms of thermal transfer either individually or collectively.

Modern day energy conservation efforts are creating a need for a variety of insulation methods and materials that are increasingly demanded by both industry and consumers. A variety of coatings have been designed and used to meet some of these demands and are readily available in the marketplace. Applications for these coatings are varied and include uses such as insulation for house and commercial buildings, insulation on carpets, insulation on curtains, textiles and other nonwovens, etc.

The reasons that liquid insulated coatings are chosen over non liquid forms of insulation are many, but one advantage is the ability of the insulative coating to conform to the shape of whatever substrate it is being applied to. For instance, insulative coatings can be sprayed onto materials in a manner that and completely and intimately covers the material surface. Also, non-liquid forms of insulations are typically more fragile and susceptible to damage from even mild abrasion or attack from rodents and insects.

Insulative coatings have many competitors and there are many areas where an insulative coating just can't compete with other types of insulation. One can think of fiberglass insulation that is installed in a house as one example. The thickness of most residential walls are 3.5″ or 5.5″ inches deep and this provides an area where thick mats of fiberglass insulation can be installed to achieve insulation values that would be hard for an insulative coating to achieve. So the goal of many insulative coating developers is to increase the efficiency of the insulative coating or in other words, slow down the rate of thermal transfer. The more efficient a coating is in regards to thermal transfer rates the thinner the coating can be and thus opening the door to more applications. Further, in most case when we talk about insulative coatings we are talking about thick coatings. This is natural because all things being equal the thickness of the coating is directly related to the reduction in thermal transfer, so the thicker the coating, the more insulation it provides.

However, there are many market areas where small increases in thermal performance can be utilized to provide effective thermal performance. For instance, windows in a building are generally responsible for a great deal of the overall heat loss from a building envelope. While a variety of heavy insulated drapes are available, they are generally bulky and block much of the natural light entering from the window. Despite these drawbacks, an improved thermal performance in window coverings can produce valuable insulative benefits. It would be further beneficial to have an insulative window covering that provides such insulative properties without adding any appreciable thickness to the product, without impacting aesthetics and shipping costs (by keeping size and weight down), and processability through machinery, etc. Further, in the case of window treatments, if the material is properly processed, the thermal enhancement may also provide the ability for the material to be transparent or translucent.

In view of the above noted shortcomings with the traditional thermal coating options, there is a need for a window treatment with an enhanced thermal performance that also maintains a sheer appearance and feel, while providing an improved and contemporary appearance.

### BRIEF SUMMARY OF THE INVENTION

In accordance with the present invention a fabric processing method is provided to enhance the thermal performance of window treatments while maintaining their light and sheer decorating value and aesthetic appearance.

The method of the present invention provides for the processing of fabrics using heat and pressure to enhance their ability to reduce thermal transfer therethrough. Further in enhancing the ability of the fabric to resist thermal transfer, the present process preserves the overall hand, feel and appearance of the fabrics allowing even sheer fabric window treatments to provide enhanced energy efficiency.

In accordance with the present invention, the fabric preferably contains a polymeric component such as polyester or the like is subjected to pressure and increased temperature to create a material fusion that resists thermal transfer as compared to the unprocessed fabric itself.

The fabric is passed between to rollers while applying heat and pressure. More specifically, the fabric is passed between at least two opposing rollers having a pressure of between 40 and 60 tons and a temperature of at or about 200 degrees Celsius. Preferably one of the rollers is a steel roller and the opposing roller is a composition roller. Further the rollers are preferably mounted in a vertical relationship allowing the fabric to be passed between them in a horizontal feed manner.

Temperature is carefully controlled so as to maintain a constant processing temperature during the entire process. Pressure is preferably exerted upwardly by the bottom of the at least two rollers to allow a consistent application of pressure.

Accordingly, it is an object of the present invention to provide a curtain window treatment with an enhanced thermal performance that also maintains a sheer appearance and feel, while providing an improved and contemporary appearance.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is an enlarged cut away perspective view of a fabric before treating with the method of the present invention;

FIG. 2 is a schematic side view of a system for performing the method of the present invention;

FIG. 3 is an enlarged cut away perspective view of a fabric after treating with the method of the present invention; and

FIG. 4 is an illustration showing the treated fabric in operation as a drape.

### DETAILED DESCRIPTION OF THE INVENTION

Now referring to the drawings, a fabric processing method is illustrated that provides an enhanced window treatment having improved thermal performance while maintaining their light and sheer decorating value and aesthetic appearance.

Generally, the method of the present invention provides for the processing of fabrics using heat and pressure to enhance their ability to reduce thermal transfer therethrough. Further in enhancing the ability of the fabric to resist thermal transfer, the present process preserves the overall hand, feel and appearance of the fabrics allowing even sheer fabric window treatments to provide enhanced energy efficiency.

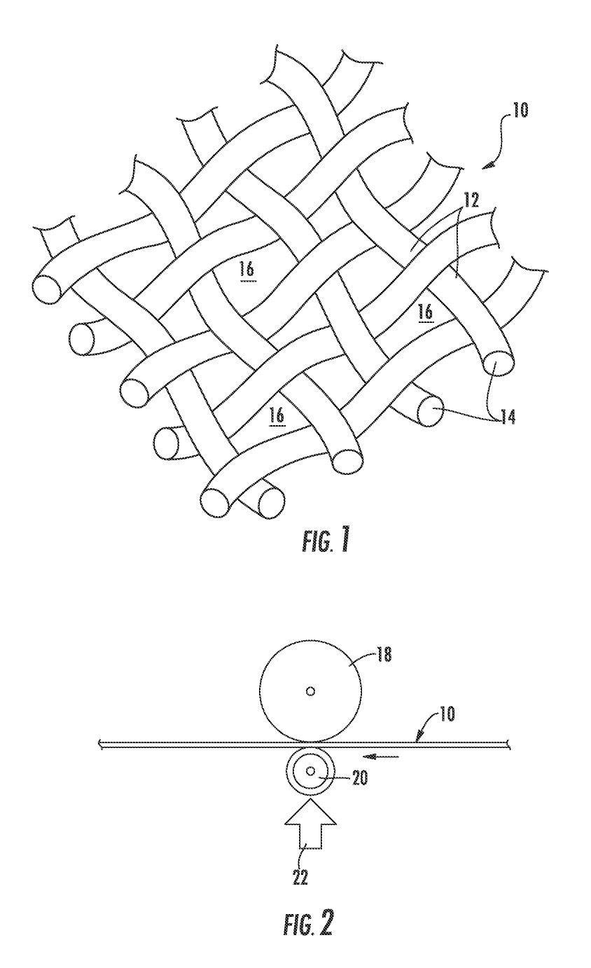

In accordance with the present invention, the untreated fabric 10 as illustrated at FIG. 1 preferably contains a polymeric component such as polyester thread 12 or the like. The thread 12 is woven to form an untreated fabric 10 as is known in the art. The resulting untreated fabric 10 is a lattice of interwoven threads 12 arranged in overlying relation to one another. When formed as a normally woven fabric the threads, as can be seen, have a substantially circular cross section 14. The thickness of each of the threads 12 causes these threads to undulate over one another leaving air spaces 16 in the regions between adjacent threads.

After the untreated fabric 10 is formed normally the untreated fabric 10 is then subjected to pressure and increased temperature to create a material fusion that results in a treated fabric 10a that resists thermal transfer as compared to the unprocessed fabric 10 itself. As can be seen at FIG. 2, the untreated fabric 10 is passed between at least two rollers 18, 20 while applying heat and pressure. More specifically, the untreated fabric 10 is passed between at least two opposing rollers that apply pressure and heat causing the fibers of the fabric to be compressed from their normally circular cross section and to at least partially fill the voids in the fabric as will be discussed in more detail below.

Preferably, the fabric is compressed between the two rollers at a pressure of between 40 and 60 tons and a temperature of at or about 200 degrees Celsius. Further, it is preferable that one of the rollers is a steel roller 18 and the opposing roller is a composition roller 20. Further still, the rollers are preferably mounted in a vertical relationship allowing the fabric to be passed between them in a horizontal feed manner.

During the processing of the fabric, the temperature is carefully controlled so as to maintain a constant processing temperature during the entire process to create a uniform compression of the fibers in order to maintain a uniform thermal performance of the finished fabric and preserve the sheer look and feel of the fabric. Pressure is preferably exerted upwardly 22 by the bottom of the at least two rollers to allow a consistent application of pressure.

As can be seen at FIG. 3, after processing the treated fibers 12a in the treated fabric 10a have been compressed to a flatter profile and are preferably at least partially fused where they cross over one another. Further the compression and flattening of each of the treated fibers 12a has caused them to expand laterally to fill in and close the interstitial spaces 16a between the adjacent treated fibers 12a. The reduction of these spaces reduces the air flow that is allowed through the fabric resulting in a reduction of convective heat loss and improved thermal performance.

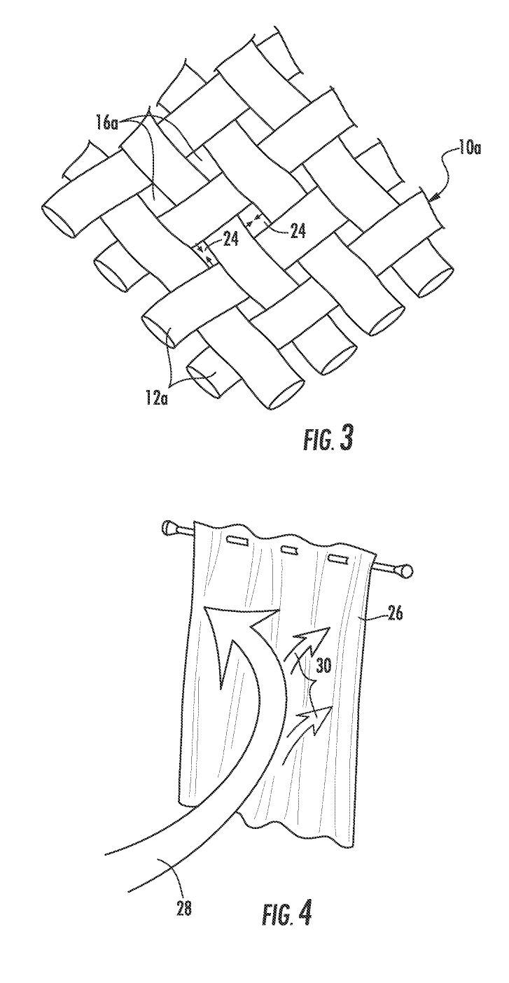

As can be seen in FIG. 4, a drape 26 formed of the sheer fabric treated in accordance with the present invention is shown in a typical window covering installation. As is known, convective air currents 28 form in a room such as the heated air illustrated rising on the interior of the drape 26. In the prior art, the drape was much more porous as the gaps between the fibers was much larger. This allowed heated air that is flowing in the convective current 28 to readily pass through the drape and be lost through the window via conduction. The present drape, by virtue of the treatment of the present invention, traps more of the convective flow 28 of air on the interior of the room. Since the airflow 30 through the drape is greatly reduced, the air containing the heat is preserved on the warm side of the drape thus demonstrating an increased insulative value in the sheer fabric.

It can therefore be seen that the present invention provides a curtain window treatment with an enhanced thermal performance that also maintains a sheer appearance and feel. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for improving the thermal resistance of a fabric, comprising:
compressing a fabric using controlled heat and pressure to at least partially flatten fibers forming said fabric, wherein said flattened fibers reduce interstitial voids within the fabric thereby enhancing a thermal resistance of said fabric.

2. The method of claim 1, wherein said fabric is a sheer fabric.

3. The method of claim 1, wherein said fabric is woven from polymeric thread.

4. method claim 1, wherein the fibers in said fabric are at least partially fused when compressed.

5. The method of claim 1, wherein said fabric is compressed using at least two rollers at a pressure of between 40 and 60 tons.

6. The method of claim 1, wherein said controlled heat is at or about 200 degrees Celsius.

7. The method of claim 1, wherein said enhanced thermal resistance is the result of a reduced airflow through said fabric.
